(19) United States
(12) Patent Application Publication
(10) Pub. No.: US 2011/0205075 A1
(43) Pub. Date: Aug. 25, 2011

(54) HAND CRANKED ENERGY EFFICIENT LIGHT

(76) Inventor: Shaam P. Sundhar, Princeton, NJ (US)

(21) Appl. No.: 12/712,677

(22) Filed: Feb. 25, 2010

(51) Int. Cl. G08B 21/00; H05B 37/02; F21L 4/00; G04B 47/00

(52) U.S. Cl. 340/636.1; 315/294; 362/183; 362/186; 368/10

(57) ABSTRACT

A hand cranked energy efficient light has a housing which houses a dynamo and associated electronic control circuitry that allows a user to turn a crank to charge a battery or capacitor which provides the energy required to operate LED lights and a clock. To help conserve energy, the number of LED light energized as well as their intensity may be varied. In one embodiment, an adjustable arm is provided to allow positioning of the light. In another embodiment, a camping lantern is provided. In another embodiment, a radio or other electronic device is also built in.

### CROSS REFERENCE TO RELATED APPLICATIONS

### Background of the Invention

For much of human history, we have been highly dependent on the sun to provide the light we need to survive. Of course fire does provide light, but unless you have a pretty big fire, the light given off is not suitable for performing many tasks that with the advent of modern lighting we take for granted.

With the advent of modern lighting, human enterprise has been able to be relatively independent of the daily cycle. This has led to increased productivity and more freedom to choose when to do tasks; however, it has come at the cost of energy and safety. Most early light sources produced a significant amount of heat in addition to light and this made them inherently dangerous and implicated in many fires.

The search for brighter light sources led to the development of halogens, which while providing a lot of light, they also get extremely hot which poses an increased fire hazard. The advent of florescent and compact fluorescent lights (CFL) are an improvement in terms of fire hazard but they bring with them other problems such as containing environmentally harmful elements such as mercury, etc.

An additional issue with some forms of artificial light is that it lacks the full spectrum that is present in natural sunlight. The lack of full spectrum light has been implicated in things like depression and it is in general not as pleasant nor conducive for human activity.

Another issue with traditional light sources is the need to have an external power source to operate. Without plugging in or connecting to a battery, the light will not operate. This can be a problem especially in areas where electricity is not a stable commodity such as developing countries.

Therefore there is a need for an electrically independent energy efficient light source that provides a more natural spectrum.

### SUMMARY OF THE INVENTION

A hand cranked energy efficient light has a housing which houses a dynamo and associated electronic control circuitry that allows a user to turn a crank to charge a battery or capacitor which provides the energy required to operate LED lights and a clock. To help conserve energy, the number of LED light energized as well as their intensity may be varied. In one embodiment, an adjustable arm is provided to allow positioning of the light. In another embodiment, a camping lantern is provided. In another embodiment, a radio or other electronic device is also built in.

Other features and advantages of the instant invention will become apparent from the following description of the invention which refers to the accompanying drawings.

### BRIEF DESCRIPTION OF THE DRAWINGS

FIG. 1 is a front view of a hand cranked energy efficient light.

FIG. 2 is a side view of the hand cranked energy efficient light shown in FIG. 1.

FIG. 3 is a close up view of a light holding portion of the hand cranked energy efficient light shown in FIG. 1.

FIG. 4 is a front view of a hand cranked energy efficient light.

FIG. 5 is a side view of the hand cranked energy efficient light shown in FIG. 4.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

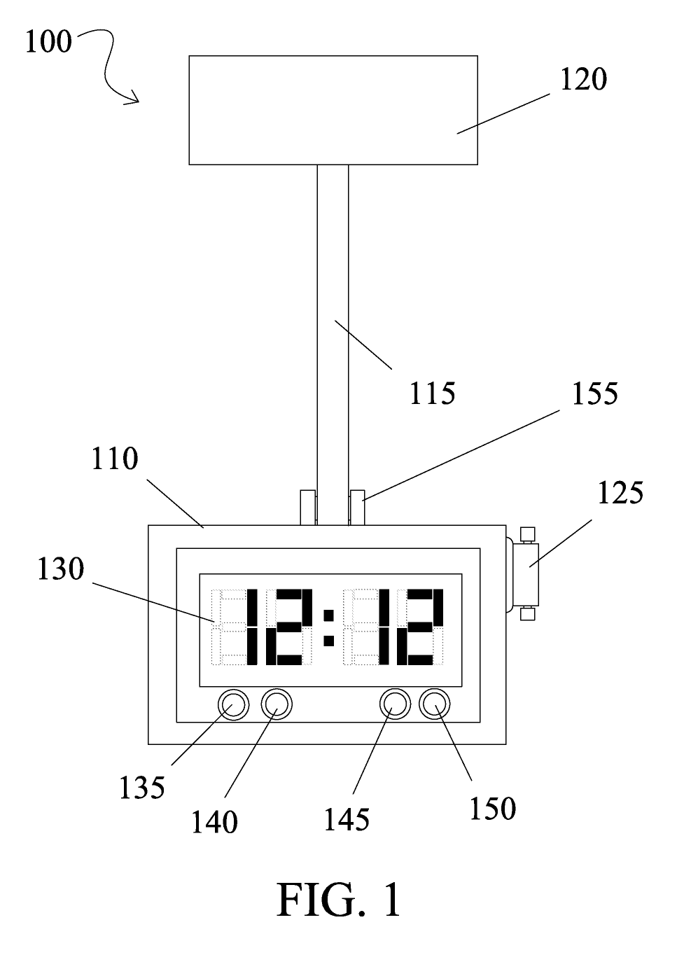

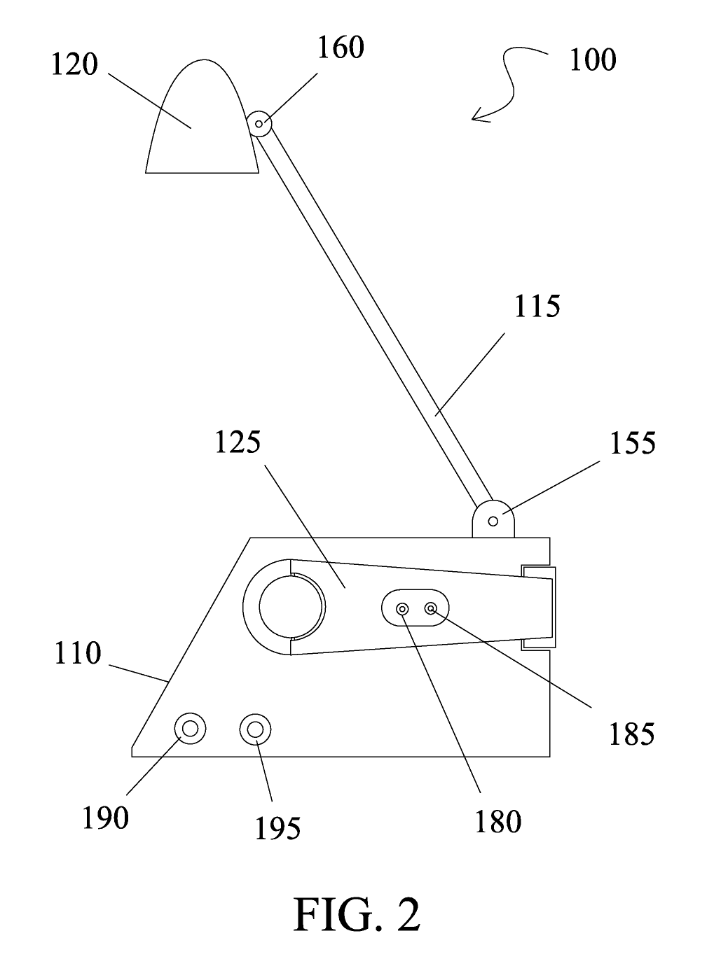

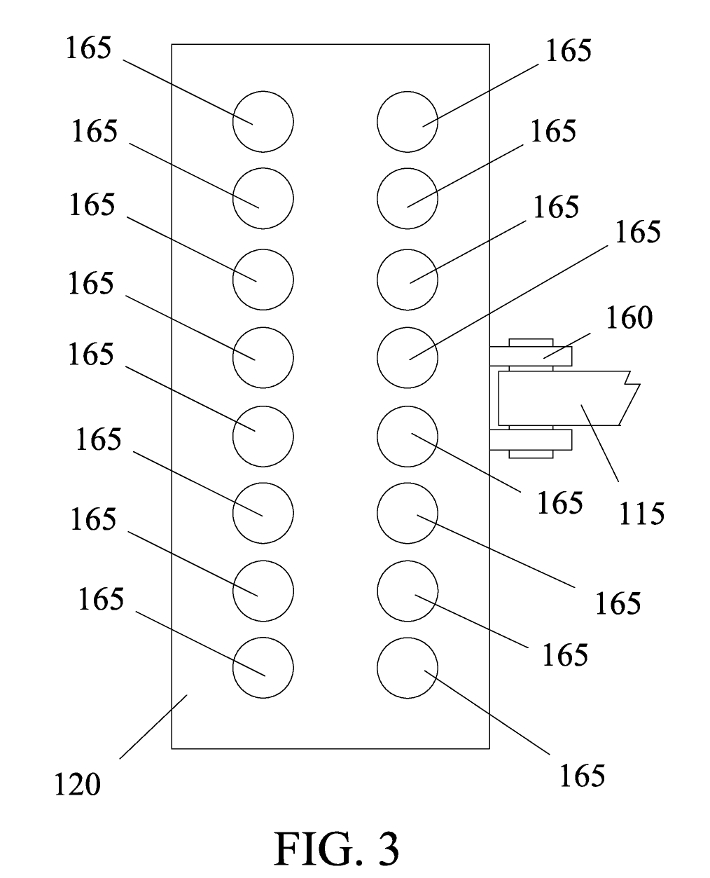

Referring to FIGS. 1-3, a hand cranked energy efficient light 100 includes a housing 110 which contains a dynamo (not shown) in communication with a hand crank 125 which folds out to allow a user to turn dynamo to produce electricity as is known in the art. Moveably attached to housing 110 is an arm 115 which holds a light shade portion 120 that has a plurality of LED light sources 165 within. In the embodiment shown, 16 white light LED lights are used to provide the light.

Arm 115 is moveably attached to housing 110 using a joint 155 and a similar joint 160 attached to shade portion 120. Additionally, arm 115 may be telescopic to allow further moveability as is known in the art. Also, it is understood that other arm configurations may be used such as two or more rods with a slider, gooseneck tube or other suitable positioning scheme as is known in the art and would be understood to be within the scope of this invention.

To enhance energy efficiency, the user can energize 8 or all 16 by selecting an appropriate control 135. Of course other kinds of controls may be used such as knobs, slide switches, buttons, digital or even voice command or other suitable control input as is known in the art. An indicator display 180 is used to fully charged state and indicator display 185 indicates charging. Again, other indicators may be used as is known in the art such as amount of charge left, time to full charge, etc. as is known in the art.

Additionally, another control 140 is used to vary the intensity of the LED lights to further enhance energy efficiency. Other controls 145 and 150 are provided to set the clock, turn the unit on and off, etc. A display 130 is provided to display the time, but display 130 could also replace controls 135, 140, 145 and 150 as is known in the art. Additionally, display 130 can be used to display environmental information such as temperature, humidity, etc. with the inclusion of the appropriate components in electrical communication with the control circuitry (not shown) contained with housing 110 as is known in the art.

An external power input 190 is provided to allow a user to operate hand cranked energy efficient light 100 using an outside power source such as electric service, auto adapter or other outside energy source as is known in the art. Additionally, a power output 195 may be provided to allow a user to power an external need such as rechargeable batteries, cell phone or other small energy requirement device.

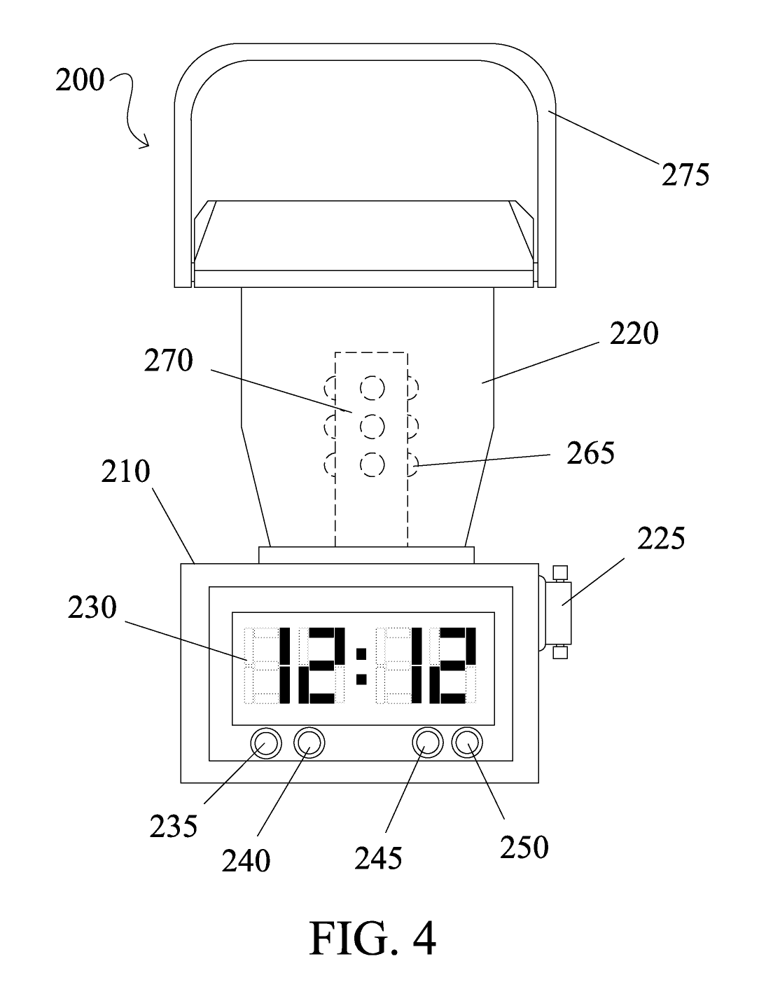

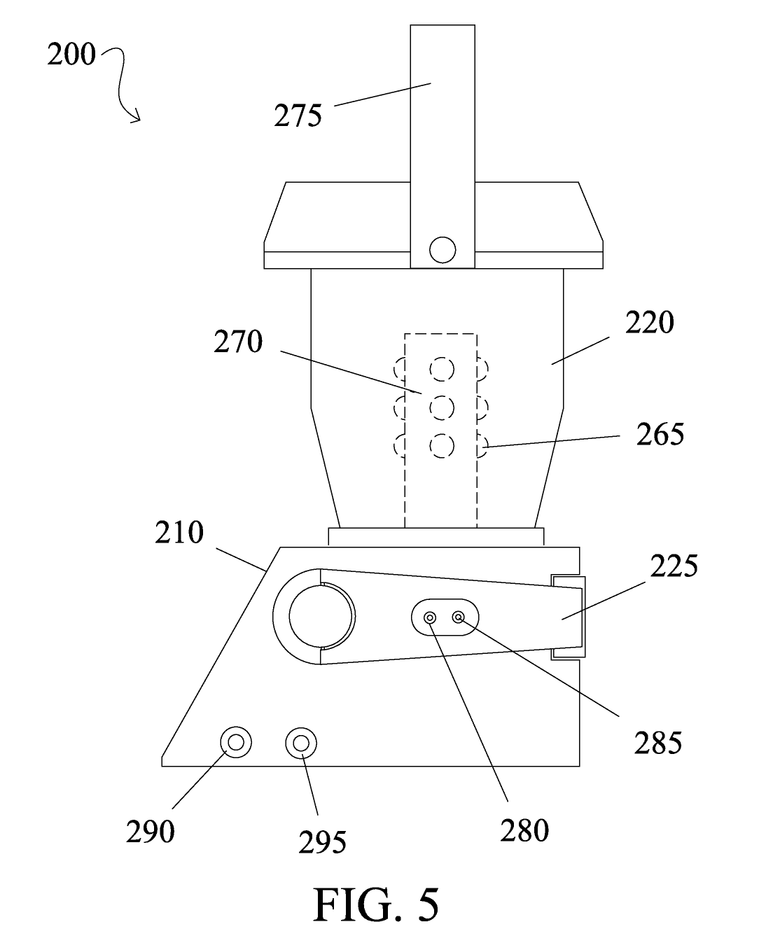

Referring now to FIGS. 4 and 5, a hand cranked energy efficient light 200 is shown having a housing 210 to contain a dynamo (not shown) and associated circuitry as discussed above. Housing 210 has a display 230 and controls 235, 240, 245 and 250 which are analogous to the features described above in relation to the embodiment shown in FIGS. 1-3. A hand crank 225 is provided to operate the dynamo.

A globe 220 is provided to diffuse light from a plurality of white light LED lights 265 arranged on a light stem 270 to provide light. In the embodiment shown, 12 lights 265 are used, but other amounts would be acceptable. A handle 275 allows the user to carry and hang hand cranked energy efficient light 210 like a tradition lantern. Additionally, some colored LED lights may be provided for added functionality such as red LED lights to indicate an emergency situation as is known in the art. In such an embodiment, an additional control would be used to select color in addition to intensity and number of lights energized as discussed above.

Again as discussed above, an external power input 290 and an external power output 295 may be provided. Housing 110 and 210 respectively is manufactured from a polycarbonate plastic, but any suitable material may be used such as but not limited to metal, recycled plastic, composite materials, etc. Additionally, control circuitry would automatically shutoff charging when full charge is achieved, whether by cranking or by attaching to an external energy source.

An internal battery (not shown) is electrically connected to the dynamo through the control circuitry in order to provide energy storage to operate without the need to continuously turn crank 125 or 225. Additionally, a large capacity capacitor may be used instead or in combination with as is known in the art.

Although the instant invention has been described in relation to particular embodiments thereof, many other variations and modifications and other uses will become apparent to those skilled in the art.

What is claimed is:

1. A hand cranked energy efficient light having built in functions comprising:
a housing;
said housing adapted to contain a dynamo and associated electronic control circuitry;
an electrical storage device in electrical communication with said electronic control circuitry whereby electricity generated by said dynamo is reversibly stored therein;
a hand crank in mechanical communication with said dynamo whereby when said hand crank is rotated, electricity is generated;
a light housing portion disposed on said housing;
said light housing portion holding at least one light source;
said light source being in electrical communication with said electrical control circuitry;
a display disposed on a surface of said housing;
said display being adapted to display information to a user;
said display being in electrical communication with said electrical control circuitry;
a light source disposed within said light holding portion; and
said light source being in electrical communication with said electronic control circuitry.

2. The hand cranked energy efficient light having built in functions according to claim 1 further comprising an electrical adapter for converting AC to DC in electrical communication with said electrical control circuitry.

3. The hand cranked energy efficient light having built in functions according to claim 1 further comprising an intensity control in electrical communication with said electrical control circuitry whereby the intensity of said at least one light source is adjusted.

4. The hand cranked energy efficient light having built in functions according to claim 1 whereby said display is a clock.

5. The hand cranked energy efficient light having built in functions according to claim 1 further comprising at least one charging indicator light in electrical communication with said electrical control circuitry.

6. The hand cranked energy efficient light having built in functions according to claim 1 whereby said light housing portion includes a lantern globe.

7. The hand cranked energy efficient light having built in functions according to claim 1 further comprising an arm disposed between said housing and said light housing portion.

8. The hand cranked energy efficient light having built in functions according to claim whereby said electrical storage device includes a battery.

9. The hand cranked energy efficient light having built in functions according to claim 4 whereby said clock includes an alarm function.

10. A hand cranked energy efficient light having built in functions comprising:
a housing;
said housing adapted to contain a dynamo and associated electronic control circuitry;
an electrical storage device in electrical communication with said electronic control circuitry whereby electricity generated by said dynamo is reversibly stored therein;
a hand crank in mechanical communication with said dynamo whereby when said hand crank is rotated, electricity is generated;
an arm attached to said housing;
a light holding portion for holding at least one light source;
said light holding portion being disposed at an end of said arm;
said other end of said arm being attached to said housing;
a display disposed on a surface of said housing;
said display being adapted to display information to a user;
said display being in electrical communication with said electrical control circuitry;
a light source disposed within said light holding portion; and
said light source being in electrical communication with said electronic control circuitry.
